(19) United States
(12) Patent Application Publication
(10) Pub. No.: US 2011/0142271 A1
(43) Pub. Date: Jun. 16, 2011

(54) METHOD FOR FREQUENCY TRANSPOSITION IN A HEARING AID AND HEARING AID

(75) Inventor: Andreas Tiefenau, Zaandam (NL)

(73) Assignee: SIEMENS MEDICAL INSTRUMENTS PTE. LTD., SINGAPORE (SG)

(21) Appl. No.: 12/970,284

(22) Filed: Dec. 16, 2010

(30) Foreign Application Priority Data
Dec. 16, 2009 (DE) 10 2009 058 415.3

(51) Int. Cl. H04R 25/00

(52) U.S. Cl. 381/316

(57) ABSTRACT

In a hearing aid offering the option of frequency transposition, sounds should still be perceivable as sounds, even after the frequency transposition. To this end, it is proposed first of all to establish sounds present in the input signal and, more particularly, the fundamental frequencies thereof and to carry out the frequency transposition as a function of the established fundamental frequencies. Here, transposed overtones are returned to the frequency grid of the fundamental frequency, and so the sound property is maintained even after the frequency transposition.

### CROSS-REFERENCE TO RELATED APPLICATION

This application claims the priority, under 35 U.S.C. §119, of German application DE 10 2009 058 415.3, filed Dec. 16, 2009; the prior application is herewith incorporated by reference in its entirety.

### BACKGROUND OF THE INVENTION

### Field of the Invention

The invention relates to a method for frequency transposition in a hearing aid and to a hearing aid for carrying out the method.

Many of the hard of hearing are burdened with the problem of not being able to perceive certain frequency ranges, even at high volumes. In order to compensate for such loss of hearing, these frequency ranges are known to be transposed to other frequency ranges that are more easily perceivable. When such a frequency transposition takes place, a distinction is mainly made between two methods: a frequency shift shifts one frequency range (e.g. 4 kHz-6 kHz) to another frequency range (e.g. 2 kHz-4 kHz). By contrast, in the case of compression, the output signal frequency emerges from multiplying the input signal frequency by a factor (e.g. 0.75). However, frequency compression is often not started at 0 Hz, but only above a certain (knee-point) frequency, e.g. 2 kHz. An example of a continuous transposition function with a linear frequency compression above 2 kHz is illustrated by the characteristic line in FIG. 1. In this example, there is no frequency transposition below the knee-point frequency of 2 kHz. Above 2 kHz there is a linear compression with the compression factor of ⅔, and so, by way of example, an input signal at a frequency of 5 kHz is emitted at the output frequency of 4 kHz.

A method for frequency transposition in a hearing aid and a hearing aid for carrying out a frequency transposition are known from the published, European patent application EP 1 441 562 A2.

Pure sinusoidal tones are almost non-existent in nature. At best they can be generated artificially using a synthesizer. However, humans perceive sounds composed of a fundamental tone and one or more harmonic overtones as a (natural) tone, i.e. as an acoustic signal at a certain frequency. The harmonic overtones are distinguished by virtue of the fact that the frequencies thereof correspond to an integer multiple of the fundamental frequency.

The natural tone or sound has oscillating components at various frequencies. A nonlinear frequency transposition and/or a frequency transposition restricted only to a portion of the audible frequency range therefore results in interference in the perception of natural tones or sounds. On the one hand, a shift in the overtone spectrum can lead to the perception of virtual fundamental tones, i.e. fundamental tones not present in the acoustic signal, and on the other hand it may be that no associated fundamental tone is perceived for a compressed overtone spectrum.

Determining sounds, i.e. fundamental tones and associated overtones, from an acoustic input signal has for example been disclosed in the Japanese patent application JP2004109742 A.

Published, non-prosecuted German patent application DE 10 2008 064 382 A1 discloses a hearing aid with a transposition arrangement. A certain frequency range of the input signal can be shifted to another frequency range of the output signal using the transposition arrangement. The shift for each frequency in the frequency range to be shifted is preferably a semitone or an integer multiple of a semitone, for example by doubling or halving the frequency. As a result the sound property of sounds present in the input signal is maintained even after the transposition.

Published, non-prosecuted German patent application DE 10 2006 019 728 A1, corresponding to U.S. patent disclosure No. 20070253585, discloses a hearing aid with a transposition arrangement, in which a compression ratio that varies over time can be set.

### SUMMARY OF THE INVENTION

It is accordingly an object of the invention to provide a method for frequency transposition in a hearing aid and a hearing aid which overcomes the above-mentioned disadvantages of the prior art devices and methods of this general type, which avoids perception interference, caused by frequency transposition, in sounds.

With the foregoing and other objects in view there is provided, in accordance with the invention a method for frequency transposition in a hearing aid. The method includes the steps of recording an input signal, determining at least one sound having a fundamental frequency and a plurality of harmonic overtones in the input signal, and carrying out a frequency transposition as per a continuous transposition function, in which there is no compression below a knee-point frequency and a linear compression with a certain compression factor above the knee-point frequency, as a function of the fundamental frequency such that overtones lying above the knee-point frequency are transposed as per a transposition function and transposed overtones are subsequently shifted to an integer multiple of the fundamental frequency.

A hearing aid as per the invention is understood to mean any instrument that supplies an output signal that can be perceived by a user as an acoustic signal, or that contributes to the supply of such an output signal, and that contains measures that are used for, or contribute to, compensating the user's individual loss of hearing. More particularly, it is a hearing aid that can be worn on the body or on the head, more particularly on or in the ear, or a hearing aid that can be wholly or partly implanted. However, instruments whose predominant purpose does not lie in compensating a loss of hearing, for example entertainment-electronics instruments (televisions, hi-fi equipment, MP3 player, etc.) or communication equipment (cellular phones, PDAs, headsets, etc), but which contain means for compensating an individual loss of hearing are also encompassed.

A hearing aid generally contains an input transducer for recording an input signal. By way of example, the input transducer is configured as a microphone, which records an acoustic signal and converts it into an electrical input signal. However, units, which have a coil or an antenna and which record an electromagnetic signal and convert it into an electrical input signal, may also be considered as input transducers. Furthermore, a hearing aid usually contains a signal-processing unit for processing and frequency-dependent amplifying of the electrical input signal. A preferably digital signal processor (DSP), whose method of operation can be influenced by programs or parameters that can be transferred onto the hearing aid, is used for signal processing in the hearing aid. This allows matching of the operating mode of the signal processing unit to both the individual loss of hearing of a hearing aid wearer and to the current hearing situation in which the hearing aid is currently being operated. The electrical input signal modified thereby is finally fed to an output transducer. The latter is generally configured as a receiver that converts the electrical output signal into an acoustic signal. However, other embodiments are also possible here, for example an implantable output transducer, which is directly connected to an auditory ossicle and excites the latter to oscillate.

According to the invention, the hearing aid contains a device for recognizing sounds contained in the electrical input signal, e.g. vocal, nasal or musical sounds. Here each sound is composed of the fundamental frequency (fundamental tone) and a plurality of overtones (the harmonics), the frequencies of which consist of an integer multiple of the fundamental frequency. In particular, this is established by spectral analysis. For this purpose, the electrical input signal is preferably transformed from time space into frequency space, for example by a fast Fourier transform (FFT). A simple option for determining the fundamental frequency of a sound consists of using a fundamental tone estimator.

Furthermore, the hearing aid as per the invention carries out a frequency transposition. Except for the exceptional case of a linear frequency transposition extending over the entire transmittable frequency range, sounds contained in the input signal are generally destroyed in the process because the overtones of a sound originally present no longer have an integer multiple of the (possibly likewise transposed) fundamental frequency after the frequency transposition. The basic idea of the invention now lies in restoring the sound property of sounds, which is lost as a result of the frequency transposition, by adaptive control of the frequency transposition. The frequency transposition is carried out as a function of the fundamental frequency of a recognized sound. In the process, the overtones of a sound are shifted in terms of the signal frequency thereof such that these again coincide with an integer multiple of the fundamental frequency (which may have likewise been shifted). As a result, a sound present in the input signal is again perceived as a sound after the frequency transposition, albeit at a different frequency.

In the case of a speech signal, there is a speaker-independent shift in the overtone spectrum that is independent of the individual fundamental frequency of a sound. As a result, the understanding of speech is improved independently of the speaker.

In order again to perceive a sound present in the original input signal as a sound after a frequency transposition, the fundamental tone may, as an alternative to the shift of overtones or in addition thereto, also be shifted with respect to its signal frequency, and so the overtones—even after the frequency transposition—are again at an integer multiple of the new fundamental frequency.

Other features which are considered as characteristic for the invention are set forth in the appended claims.

Although the invention is illustrated and described herein as embodied in a method for frequency transposition in a hearing aid and a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a graph showing a characteristic line of a frequency transposition;

FIG. 2 is a block diagram of a hearing aid according to the prior art;

FIG. 3 is a graph showing a generation of a virtual fundamental frequency according to the invention;

FIG. 4 is a graph showing a shift of overtones to a closest integer multiple of the fundamental frequency according to the invention;

FIG. 5 is a graph showing the shift of overtones to a next lower integer multiple of the fundamental frequency according to the invention; and

FIG. 6 is a graph showing the shift of a number of overtones by a certain multiple of the fundamental frequency according to the invention.

### DETAILED DESCRIPTION OF THE INVENTION

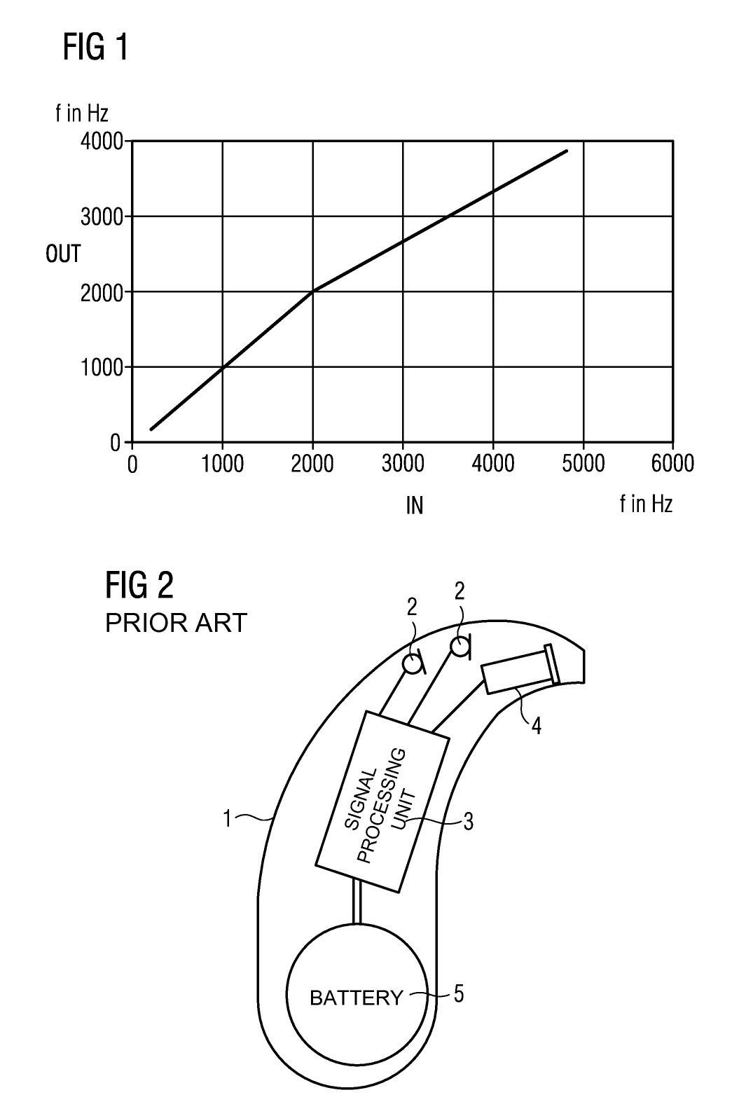

Referring now to the figures of the drawing in detail and first, particularly, to FIG. 1 thereof, there is shown a compression characteristic line for a hearing aid, in which an input signal (IN) is compressed in terms of the signal frequency above the knee point of 2000 Hz (2 kHz). In the process, the frequency range from 2000 Hz to 5000 Hz is imaged to the frequency range 2000 Hz to 4000 Hz in the output signal (OUT).

FIG. 2 shows the design of a hearing aid according to the prior art in the much-simplified block diagram. In principle, the main components of hearing aids are one or more input transducers, an amplifier and an output transducer. In general, the input transducer is configured as a sound receiver, e.g. a microphone, or an electromagnetic receiver, e.g. an induction coil. The output transducer is usually implemented as an electroacoustic transducer, e.g. a miniaturized loudspeaker or receiver, or as an electromechanical transducer, e.g. a bone conduction receiver. The amplifier is usually integrated into a signal-processing unit. This principle design is illustrated in FIG. 2 using the example of a behind-the-ear hearing aid. One or more microphones 2 for recording sound from the surroundings are fitted into a hearing aid housing 1 provided to be worn behind the ear. A signal-processing unit 3, which is likewise integrated in the hearing aid housing 1, processes the microphone signals and amplifies them. The output signal from the signal-processing unit 3 is transmitted to a loudspeaker or receiver 4, which outputs an acoustic signal. If necessary, the sound is transferred to the eardrum of the wearer of the hearing aid using a sound tube, which is fixed in the auditory canal with an ear mold. A battery 5 likewise integrated in the hearing aid housing 1 supplies the hearing aid, and, more particularly, the signal-processing unit 3 with energy.

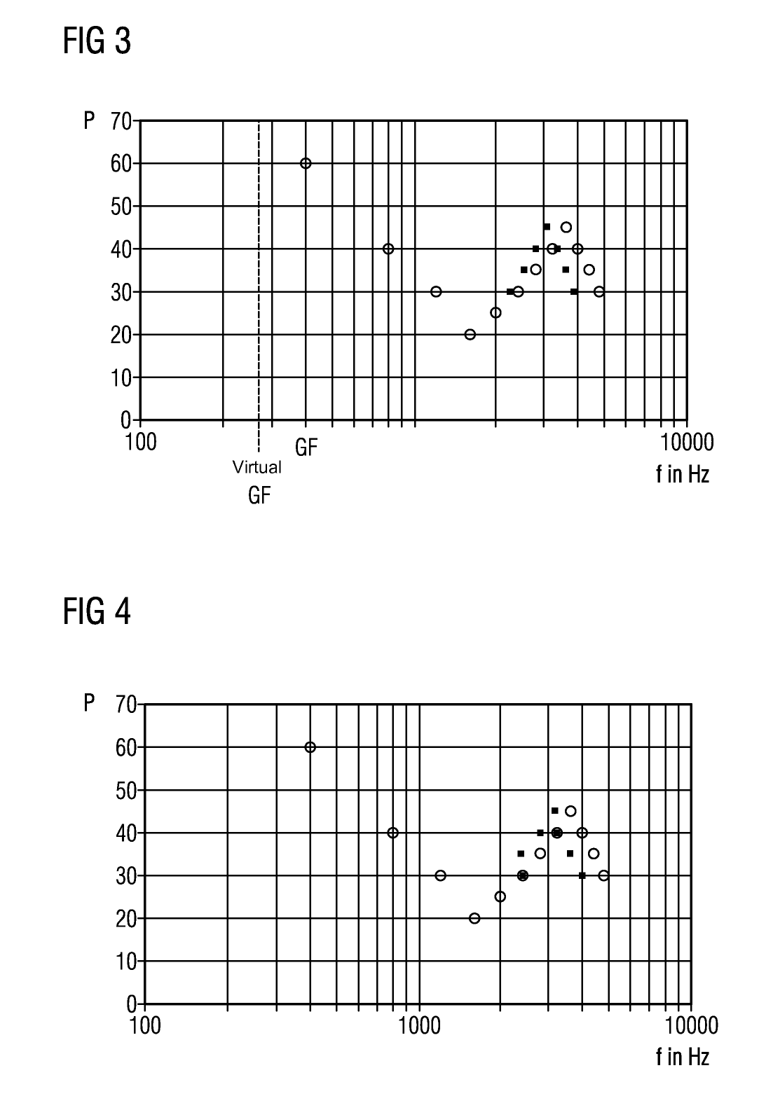

FIG. 3 shows the effects a frequency transposition as per FIG. 1 has on a sound with a fundamental frequency GF at 400 Hz and overtones at 800 Hz, 1200 Hz, 1600 Hz, 2000 Hz, 2400 Hz, 2800 Hz, 3200 Hz, 3600 Hz, 4000 Hz, 4400 Hz and 4800 Hz, which are illustrated by circles at the respective signal frequency and at the associated signal level P. Moreover, the black squares illustrate the transposed overtones above 2 kHz at the frequencies 2267 Hz, 2533 Hz, 2800 Hz, 3067 Hz, 3333 Hz, 3600 Hz and 3867 Hz (rounded to integer values). However, this overtone spectrum would be associated with a virtual fundamental frequency at 267 Hz (rounded), which is not present in the original sound. The perception of the sound present at the outset is impaired accordingly by the frequency transposition.

A first option for the invention now consists of reassigning the transposed overtones of the sound to the originally present 400 Hz grid such that each transposed overtone is shifted to the closest frequency in the 400 Hz grid. Accordingly, the transposed overtones at 2267 Hz and 2533 Hz are shifted to the signal frequency 2400 Hz, the transposed overtones at 3067 Hz and 3333 Hz are shifted to the signal frequency 3200 Hz and the transposed overtone at 3867 Hz is shifted to the signal frequency 4000 Hz. The transposed overtones at 2800 Hz and 3600 Hz are already on the 400 Hz grid of the sound and so there is no need to shift these. The spectrum of the original sound and the sound transposed as per the exemplary embodiment are illustrated in FIG. 4. In general, at least one sound is determined in a sound signal in this method, and a frequency transposition is carried out as a function of an established fundamental frequency of the sound such that at least one frequency range is transposed to another frequency range as a function of a transposition function and transposed overtones of the sound are shifted to the closest integer multiple of the fundamental frequency. The fundamental frequency can be the fundamental frequency of the original sound, or a fundamental frequency of the transposed sound, which differs from the former fundamental frequency.

Thus, according to the invention, there first of all is a frequency transposition of an input signal according to a certain transposition function, as in the previous case. Additionally, there is a further frequency transposition for certain signal components or frequencies as a function of an established fundamental frequency of a sound. If need be, the latter option may be optionally switched on or off in a hearing aid, for example by programming the hearing aid.

Should—as in this exemplary embodiment—a plurality of transposed overtones come to rest at the same frequency after the frequency transposition according to the invention (in the exemplary embodiment, these are the original overtones at 2400 Hz and 2800 Hz, which lie at 2400 Hz after the frequency transposition, and the original overtones at 3600 Hz and 4000 Hz, which lie at 3200 Hz after the frequency transposition), the transposed overtone with the highest signal level is decisive. Transposed overtones at the same frequency that have a lower signal level can therefore also be suppressed.

Another option for the invention consists of shifting the overtones, which were at first transposed according to a transposition function, to the respectively next lower frequency of the original 400 Hz grid of the sound. Accordingly, the transposed overtone at 2267 Hz is shifted to the signal frequency 2000 Hz, the transposed overtone at 2533 Hz is shifted to the signal frequency 2400 Hz, the transposed overtone at 3067 Hz is shifted to the signal frequency 2800 Hz, the transposed overtone at 3333 Hz is shifted to the signal frequency 3200 Hz and the transposed overtone at 3867 Hz is shifted to the signal frequency 3600 Hz. FIG. 5 illustrates the spectrum of the original sound and the sound transposed according to this exemplary embodiment. In general, at least one sound is established in a tone signal in this method, and a frequency transposition is carried out as a function of an established fundamental frequency of the sound such that at least one frequency range is transposed into another frequency range as a function of a transposition function and transposed overtones of the sound are shifted to the next lower integer multiple of the fundamental frequency.

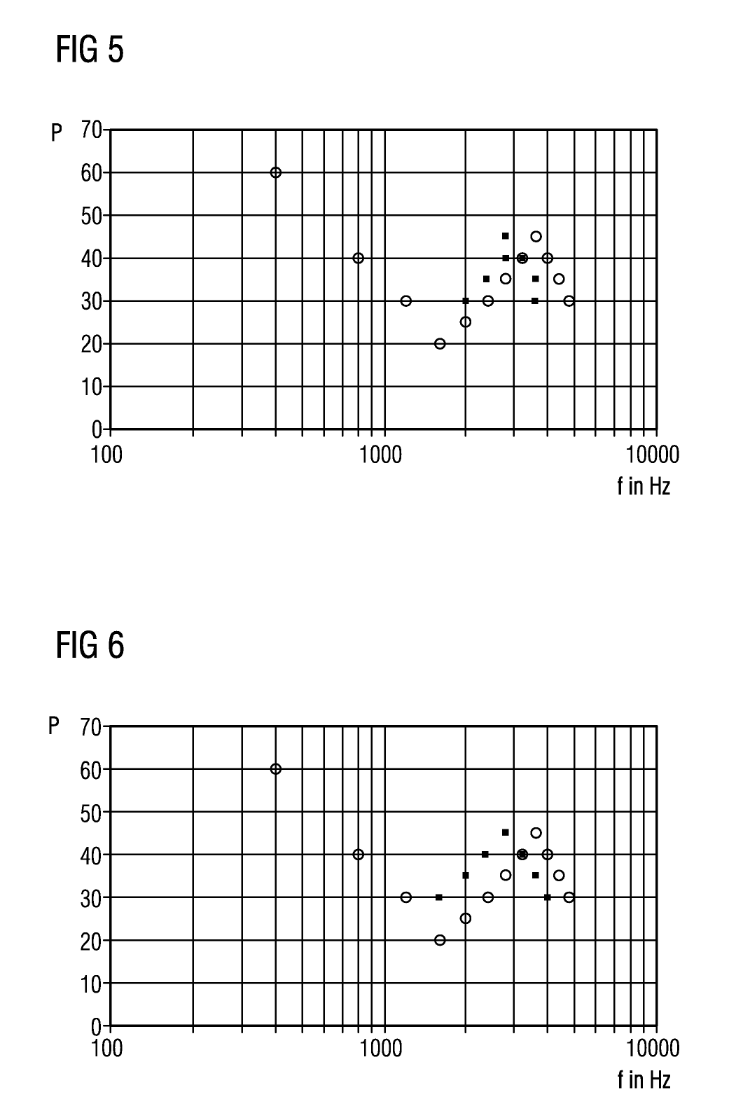

Another option for the invention consists of shifting the entire overtone spectrum of a sound in a certain frequency range. This is illustrated in FIG. 6, in which all overtones over 2 kHz present at the outset are shifted toward lower frequencies by twice the fundamental frequency, i.e. by 800 Hz in this exemplary embodiment.

It goes without saying that, in addition to the options mentioned in an exemplary fashion, there is a multiplicity of additional options or algorithms for recreating a sound from a sound in the original input signal after a frequency transposition of the input signal that at first destroys the sound property. In the process, there may also be an adaptation of the fundamental tone and/or overtones also in that frequency range not originally affected by the frequency transposition, for example by shifting the original fundamental frequency or by synthetically generating a tone with the new fundamental frequency.

The options for adaptive control of a frequency transposition as a function of the fundamental frequency, shown using the example of a single sound with the fundamental frequency of 400 Hz, may be applied simultaneously to a multiplicity of sounds present in the input signal.

The signal processing in the hearing aid, more particularly the finding of sounds in the input signal, the frequency transposition and the inventive adaptation of the signal frequency of the transposed overtones for maintaining the sound property are preferably carried out in the frequency space. To this end, the signal processing transforms the input signal into the frequency space and subsequently performs an inverse transform.

1. A method for frequency transposition in a hearing aid, which comprises the steps of:
recording an input signal;
determining at least one sound having a fundamental frequency and a plurality of harmonic overtones in the input signal; and
carrying out a frequency transposition as per a continuous transposition function, in which there is no compression below a knee-point frequency and a linear compression with a certain compression factor above the knee-point frequency, as a function of the fundamental frequency such that overtones lying above the knee-point frequency are transposed as per a transposition function and transposed overtones are subsequently shifted to an integer multiple of the fundamental frequency.

2. The method according to claim 1, which further comprises shifting respectively the overtones in each case by a certain integer multiple of the fundamental frequency.

3. The method according to claim 1, which further comprises shifting the transposed overtones to a next lower integer multiple of the fundamental frequency.

4. The method according to claim 1, which further comprises shifting respectively the transposed overtones to a closest integer multiple of the fundamental frequency.

5. The method according to claim 1, which further comprises transforming the input signal from time space to frequency space and at least one of a sound or the frequency transposition is established in the frequency space.

6. A hearing aid, comprising:
a processing unit programmed to:
record an input signal;
determine at least one sound with a fundamental frequency and a plurality of harmonic overtones in the input signal; and
carry out a frequency transposition as per a continuous transposition function, in which there is no compression below a knee-point frequency and a linear compression with a certain compression factor above the knee-point frequency, as a function of the fundamental frequency such that overtones lying above the knee-point frequency are transposed as per a transposition function and transposed overtones are subsequently shifted to an integer multiple of the fundamental frequency.
